(19) United States
(12) Patent Application Publication
(10) Pub. No.: US 2013/0186283 A1
(43) Pub. Date: Jul. 25, 2013

(54) CLEANING SYSTEM FOR HOT BEVERAGE MACHINES

(71) Applicant: Michael Koch, Garmisch (DE)

(72) Inventor: Michael Koch, Garmisch (DE)

(73) Assignee: Macchiavalley Produktions GmbH, Garmisch-Partenkirchen (DE)

(21) Appl. No.: 13/877,669

(22) PCT Filed: May 23, 2012
(86) PCT No.: PCT/EP12/59576

§ 371 Date: Apr. 4, 2013

(30) Foreign Application Priority Data
Jun. 10, 2011 (DE) 10 2011 077 435.1

(51) Int. Cl. A47J 31/60; C25F 1/00

(52) U.S. Cl. CPC A47J 31/60; C25F 1/00
USPC 99/323.3; 205/705; 204/275.1; 204/274

(57) ABSTRACT

A method for cleaning the milk system of a drink machine for milk-containing hot beverages includes a feed line that feeds milk from a storage container, a central unit in which the milk is heated and processed, and an output unit via which the milk-containing hot beverage prepared in the central unit is dispensed, wherein the feed line is coupled to a cleaning device including an electrolytic cell, a cleaning solution is fed into the milk system from the cleaning device, which solution passes the electrolytic cell and an electrical current is applied to the cleaning solution by the electrolytic cell until electrolysis products having a disinfectant effect are forming and/or the electrical conductivity of the cleaning solution is monitored by the electrolytic cell.

### TECHNICAL FIELD

This disclosure relates to a method for cleaning the milk system of a drink machine for milk-containing hot beverages, a cleaning device which can be used in such a method and a hot beverage machine having such a cleaning device.

### BACKGROUND

Modern hot beverage machines such as coffee machines are often fully automatic machines which dispense different types of coffee such as espresso, white coffee or cappuccino at the push of a button. To prepare the milk-containing coffee drinks, usually, milk is fed from a corresponding storage reservoir via a feed line by a milk pump, heated in the coffee machine, frothed where necessary and mixed with coffee. The resulting coffee drink is dispensed via an output unit of the coffee machine.

The problem therein is that milk strongly tends to contamination. This is why the milk system of a hot beverage machine, i.e., all parts of the machine that contact the milk, have to be cleaned at regular intervals. To that end, usually the mentioned feed line for milk is transferred into a container which contains a cleaning agent. With the pump which is usually provided for the milk supply, the cleaning agent can be fed into the milk system to clean the same up to the output unit. Such a method is known, for example, from EP 1 878 370 A1. The feed line of EP '370 is transferred into a rinsing zone for cleaning, which zone includes a hot water intake opening and/or a steam intake opening and/or a cleaning agent intake opening and/or a cold water intake opening.

The occasionally complicated handling of individual cleaning steps is disadvantageous in known cleaning methods. The cleaner to be used is mostly present as a concentrate and is diluted with water prior to cleaning According to experience, the concentrations set by the operating personnel are frequently too low or too high. After cleaning, rinsing the system with water is to be effected where even the last remainders of the cleaning agent have to be removed from the milk system. In such a procedure, mistakes are often made since the moment when there are no longer cleaning agent remainders in the milk system is not clearly discernable to operating personnel. Even in the case where cleaning is properly carried out, there always still remain residual microbial contaminations in the milk system which can quickly resume multiplication after cleaning. To remove those contaminations, it would be necessary to disinfect the milk system. However, a practical solution for that has not yet been available on the market.

It would therefore be helpful to provide an improved solution for cleaning the milk system of hot beverage machines.

### SUMMARY

I provide a method of cleaning a milk system of a drink machine for milk-containing hot beverages including a feed line that feeds the milk from a storage container, a central unit in which the milk is heated and processed, and an output unit via which the milk-containing hot beverage prepared in the central unit is dispensed, wherein the feed line is coupled with a cleaning device which includes an electrolytic cell, a cleaning solution is fed into the milk system from the cleaning device, which solution passes the electrolytic cell, and an electrical current is applied to the cleaning solution by the electrolytic cell until electrolysis products having a disinfectant effect are formed, and the electrical conductivity of the cleaning solution is monitored by the electrolytic cell.

I also provide a cleaning device for cleaning a milk system of a hot beverage machine for milk-containing hot beverages including a rinsing zone which can be filled with a cleaning solution to receive the feed line, a supply line for the cleaning solution which ends in the rinsing zone and two electrodes spaced apart from one another that apply an electrical current to the cleaning solution and are arranged in the rinsing zone or in the supply line for the cleaning solution.

I further provide a hot beverage machine for milk-containing hot beverages comprising a milk system coupled to the cleaning device.

### BRIEF DESCRIPTION OF THE DRAWINGS

FIG. 1 schematically illustrates a coffee machine with a milk storage container.

FIG. 2 schematically illustrates a coffee machine with a cleaning device.

### DETAILED DESCRIPTION

I provide a method to clean the milk system of a drink machine for milk-containing hot beverages. Such a milk system always comprises:
a feed line that feeds the milk from a storage container,
a central unit where the milk is heated and processed, and
an output unit via which the milk-containing hot beverage prepared in the central unit is dispensed.

The drink machine can, for example, be a coffee machine or also a cocoa machine. Correspondingly, processing the milk in the central unit includes, for example, mixing the milk with coffee or cocoa or the frothing of the milk.

My method of cleaning the milk system couples the feed line of the system to a cleaning device comprising at least one electrolytic cell. As generally known, electrolysis is a process where an electrical current forces a chemical reaction. The principle of electrolysis is known and thus does not require a detailed technical explanation. What is important is that by electrolysis of aqueous solutions, substances with high oxidation potential and thus also high disinfection potential such as ozone, hydrogen peroxide and chlorine, can be generated without any problems.

Thus, a cleaning solution is fed from the cleaning device into the milk system with the cleaning solution passing the at least one electrolytic cell prior to feeding into the milk system. Particularly preferably, an electrical current is applied to the cleaning solution by the electrolytic cell until electrolysis products having a disinfectant effect (such as the substances indicated) are formed. Thus, the electrolytic cell allows that not only a simple cleaning of the milk system of a drink machine for hot beverages is effected, but also disinfection takes place at the same time.

The polarity of the electrodes is reversed at regular or irregular intervals, for example, with each new cleaning procedure to counteract scaling on the surface of the electrodes of the electrolytic cell.

An electrolytic cell can also readily be used as a sensor for the conductivity of an aqueous solution. This is also well-known and, therefore, does not require further explanation.

Also particularly preferably, electrical conductivity of the cleaning solution is monitored by the electrolytic cell which serves as a sensor. This has several advantages which will subsequently be explained in more detail.

The particularly preferred examples can generally be realized independently from one another. Further particularly preferably, the electrolytic cell is used both as a sensor and to generate electrolysis products having a disinfectant effect, also simultaneously, if applicable.

The conductivity values measured by the electrolytic cell can readily be used to determine the concentration of a cleaner in the cleaning solution. The cleaning solution is preferably formed by tap water (which may be pre-conditioned, for example, softened) and a cleaner concentrate. It is particularly advantageous to set or adjust the mixing ratio of the two components on the basis of the conductivity measured by the electrolytic cell. Suitable settings are required to set the mixing ratio which will later be explained separately in more detail.

Thus, over- or low-concentrations of cleaner concentrate in the cleaner solution can be determined in a simple manner and can be balanced by counteracting during the metered addition of the cleaner concentrate. This can readily be effected fully automatically by use of a suitable electronic control so that errors made by operating personnel can be ruled out.

In the case of a suspicious decrease in the concentration of cleaner in the cleaning solution measured by the electrolytic cell, an acoustical or optical warning signal can be generated so that operating personnel are warned that the cleaner concentration is too low and the cleaner concentrate needs replenishment, if applicable.

It is required to rinse the milk system with tap water (which may also be preconditioned) after cleaning to remove cleaner residues from the milk system. Particularly preferably, the duration of rinsing is controlled based on the conductivity values measured by the electrolytic cell. The electrolytic cell can exactly indicate the moment in which cleaner-free water is present. In the case where volume and flow velocity are known, the moment when the rinsing process is completed can readily be calculated.

The cleaning device to clean the milk system of a hot beverage machine comprises a rinsing zone which can be filled with cleaner solution for receiving a milk feed line of the milk system to be cleaned, a supply line for cleaner solution which ends into the rinsing zone, and two electrodes spaced apart from one another to apply an electrical current to the cleaner solution arranged in the rinsing zone or in the supply line for the cleaner solution.

The cleaning device is particularly suitable for use in my method.

Generally, the rinsing zone may have the same features as the rinsing zone known from EP 1 878 370 A1.

The device preferably comprises a supply line for tap water (having a pressure reducer installed, if applicable), a reservoir for cleaner concentrate and, as already mentioned above, a device to meter addition of cleaner concentrate into the tap water. For this purpose, preferably electronically controllable valves are provided, in particular magnetic valves in which the through flow of tap water or cleaner can, for example, be controlled by pulsed timing of the opening and closing mechanism.

To ensure that the reservoir is filled with the appropriate cleaner concentrate, the reservoir may have an electronic lock including a radio frequency identification (RFID) reader, for example, which can exclusively be opened with a complementary RFID chip. Such a complementary RFID chip can, for example, be bonded to the wrapping of the cleaner concentrate. The communication between the RFID components can of course be encrypted.

With an electronic lock in the form of complementary RFID transmitters and receivers or other electronic sensors or switches, it can, for example, also be ensured that the method can only be started if the milk feed line of the milk system to be cleaned, for example, a lance, is properly arranged in the rinsing zone of the cleaning device which can be configured in a shaft-shaped manner, for example.

Particularly preferably, it is possible to integrate the cleaning device into a cooling device. The cooling device can in particular be of a type already used to cool the milk needed in the hot beverage machine to be cleaned.

Correspondingly, also, a hot beverage machine, particularly for milk-containing hot beverages which has a milk system coupled to a cleaning device or which comprises such a device, is provided.

Further features result from the subsequent description of the Drawings. It is explicitly pointed out that all facultative aspects of the method or the device described herein can be realized in each case on their own or in a combination with one or several of the further described, facultative aspects in an example.

The following description merely serves for explanation purposes and for a better understanding and does not have a limiting character at all.

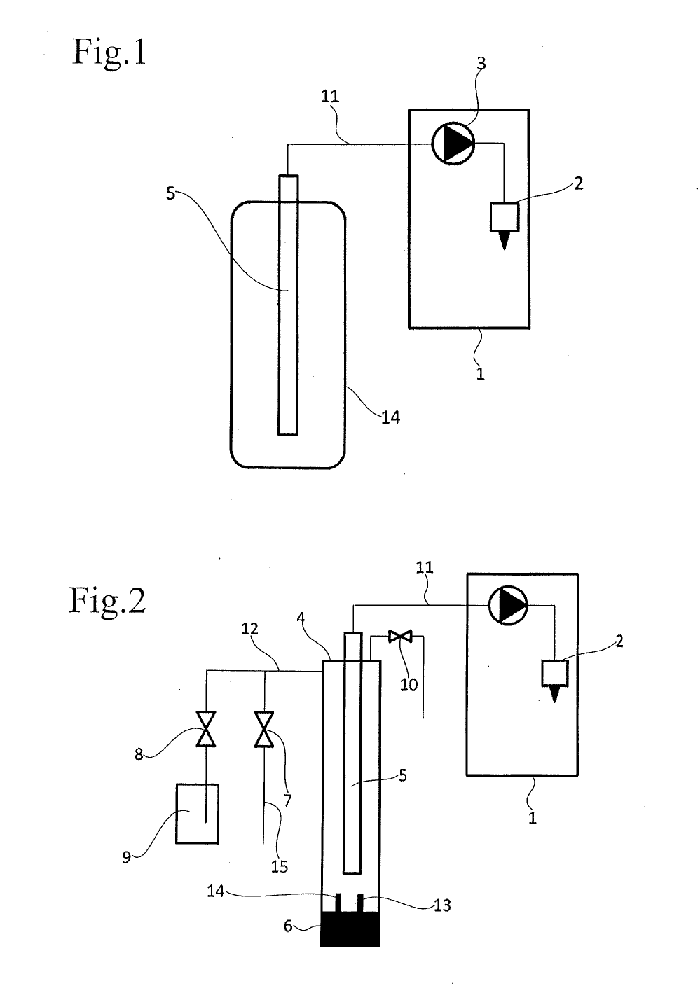

As an example of a drink machine for milk-containing hot beverages, FIG. 1 shows a coffee machine 1 with connected storage container for milk (schematic illustration). To prepare a milk-containing coffee drink, milk is fed by the pump 3 from the milk storage container 14 via a lance 5 used as a feed line into the coffee machine 1. In the latter, the milk is heated and mixed with coffee. The resulting hot beverage is dispensed via the output unit 2 of the coffee machine 1. To clean the milk path of the coffee machine 1 shown, the lance 5 is transferred, according to the prior art, into another storage container (not shown) which is filled with a cleaner solution. However, my method is shown in FIG. 2.

FIG. 2 schematically shows a coffee machine 1 having a coupled cleaning device. To clean the milk system of the coffee machine 1, which system comprises besides the output device 2 and parts of the pump 3 also the supply line 11 including the lance 5, the lance 5 is introduced into the rinsing shaft 4 which serves as a rinsing zone. Tap water 15 is mixed with cleaner concentrate from the reservoir 9 in the mixing path 12. During the cleaning procedure, the milk pump 3 operates. Mixing the cleaner concentrate with the tap water 15 is effected by the magnetic valves 7 and 8. With pulsed timing of the magnetic valves 7 and 8, i.e., switching on or off the valves 7 or 8, respectively, the desired cleaner concentration is set. The cleaner concentration can be set optimally by use of the electrolytic cell consisting of the electrodes 13 and 14 which cell operates as a conductivity measuring cell. If the concentration deviates from a desired value, the deviation is registered by the electrodes as a decrease or increase in conductivity. For example, pulsing the magnetic valves 7 and 8 can be adjusted using an electronic control to which the deviation is transmitted. The cleaner solution flows into the cleaning shaft 4 via the line 12 which shaft can be vented by the valve 10. The cleaner solution is suctioned out of the cleaning shaft 4 via the lance 5 and the line 11 into the coffee machine 1 and is finally drained from the coffee machine 1 via the output unit 2. During cleaning, an electrical current is applied to the electrolytic cell and in doing so, a disinfectant such as ozone, hydrogen peroxide or chlorine (depending on the composition of the cleaning solution) is produced. The disinfectant disinfects the milk system during cleaning After cleaning and disinfection, the entire system is rinsed with water. For that purpose, the valve 7 is completely opened while the valve 8 remains closed. With the electrolytic cell which in this case again operates as a conductivity measuring cell, complete rinsing out of the cleaner or the disinfectant can be achieved.

1-9. (canceled)

10. A method of cleaning a milk system of a drink machine for milk-containing hot beverages comprising:
a feed line that feeds the milk from a storage container,
a central unit in which the milk is heated and processed, and
an output unit via which the milk-containing hot beverage prepared in the central unit is dispensed,
wherein
the feed line is coupled with a cleaning device which comprises an electrolytic cell,
a cleaning solution is fed into the milk system from the cleaning device, which solution passes the electrolytic cell, and
an electrical current is applied to the cleaning solution by the electrolytic cell until electrolysis products having a disinfectant effect are formed, and
the electrical conductivity of the cleaning solution is monitored by the electrolytic cell.

11. The method according to claim 10, wherein in the central unit the milk is mixed with coffee or cocoa.

12. The method according to claim 10, wherein polarity of the electrodes in the electrolytic cell is reversed at regular or irregular intervals.

13. The method according to claim 10, wherein polarity of the electrodes in the electrolytic cell is reversed with each new cleaning procedure.

14. The method according to claim 10, wherein the cleaning solution is composed of tap water and a cleaner concentrate and a mixing ratio of the two components is set based on conductivity measured by the electrolytic cell.

15. The method according to claim 10, wherein the milk system is rinsed with tap water after cleaning and duration of the rinsing is controlled based on conductivity measured by the electrolytic cell.

16. A cleaning device for cleaning a milk system of a hot beverage machine for milk-containing hot beverages comprising a rinsing zone which can be filled with a cleaning solution to receive the feed line, a supply line for the cleaning solution which ends in the rinsing zone and two electrodes spaced apart from one another that apply an electrical current to the cleaning solution and are arranged in the rinsing zone or in the supply line for the cleaning solution.

17. The device according to claim 16, further comprising a supply line for tap water, a reservoir for cleaner concentrate and a device that meters addition of cleaner concentrate to the tap water.

18. The device according to claim 16, further comprising an integrated cooling device.

19. The device according to claim 16, further comprising an electronic lock in the form of complementary radio frequency identification (RFID) transmitters and receivers or electronic sensors or switches that ensure that the cleaning can only be started if the milk feed line is arranged in the rinsing zone.

20. A hot beverage machine for milk-containing hot beverages comprising a milk system coupled to a device according to claim 16.
